(19) United States
(12) Patent Application Publication
(10) Pub. No.: US 2016/0189321 A1
(43) Pub. Date: Jun. 30, 2016

(54) Integrated Unique Device Identifier (UDI) Patient Safety Notification System

(71) Applicant: Dassault Systèmes Americas Corp., Waltham, MA (US)

(72) Inventors: Arieh Halpern, Tarzana, CA (US); Barry Foster, Acton, MA (US)

(21) Appl. No.: 14/972,724

(22) Filed: Dec. 17, 2015

Related U.S. Application Data
(60) Provisional application No. 62/097,819, filed on Dec. 30, 2014.

(51) Int. Cl. G06Q 50/22; G06Q 30/00

(52) U.S. Cl. CPC G06Q 50/22; G06Q 30/016

(57) ABSTRACT

Embodiments provide methods and systems for medical device safety notification. One such embodiment begins by receiving medical device complaints. Next, indications of the received complaints are stored, each complaint includes a respective unique device identifier (UDI) of a corresponding medical device. In turn, each respective manufacturer of the corresponding medical device is notified of the complaint. Then, in response to instructions from the respective manufacturer, safety notifications are generated and sent about the corresponding medical device.

### RELATED APPLICATION(S)

This application claims the benefit of U.S. Provisional Application No. 62/097,819, filed on Dec. 30, 2014. The entire teachings of the above application are incorporated herein by reference.

### BACKGROUND OF THE INVENTION

The invention generally relates to the field of medical devices. Specifically, medical device safety notifications. A medical device is an item either used for diagnosis, treatment, or prevention of disease, or intended to affect the body, that does not achieve its primary purpose through chemical action or metabolism within the body. FIG. 1 lists example medical devices, amongst others, and notes the end user of the example devices. Exemplary medical devices include ventilators and intravenous pumps, which are used by healthcare facilities, e.g., hospitals, and pacemakers and knee replacements, which are used by patients.

Medical devices provide excellent benefits to patients and care providers alike. However, medical devices are not flawless. Medical devices can fail or be harmful to patients for a variety of reasons, including, manufacturer defects, unforeseen interactions, and improper use.

### SUMMARY OF THE INVENTION

Embodiments of the present invention provide methods and systems for medical device safety notification. According to at least one example embodiment a method for medical device safety notification begins by receiving, by a digital processor, medical device complaints. Next, indications of the received medical device complaints are stored, by the digital processor, in a memory coupled to the digital processor. In such an embodiment, each complaint includes a respective unique device identifier (UDI) of a corresponding medical device. Such a method continues by automatically notifying respective manufacturers of the medical devices, of the complaints. Finally, safety notifications are generated and sent about the corresponding medical device in response to received instructions from the respective device manufacturer.

According to an embodiment of the present invention, the medical device complaints are received from at least one of a patient, a hospital, a healthcare provider, and a complaint database. In embodiments, the safety notifications are sent in a HIPPA compliant manner. According to the principles of the present invention, safety notifications may be automatically sent to at least one of a patient, a hospital, a health care provider, and a regulatory body, such as the FDA. Notifications may be sent on behalf of the device manufacturers and/or on behalf of a third party.

According to embodiments of the present invention, the safety notifications may be automatically sent via any means known in the art. For example, notifications may be sent via SMS text message, e-mail, letter, facsimile, and phone. An embodiment of the present invention further comprises determining acknowledgment status of the sent safety notifications. Further still, another embodiment comprises determining recipients of the safety notifications. In such an embodiment the recipients may be determined using a database of UDIs. Embodiments may also send safety notifications based upon respective preferences of the recipients.

An alternative embodiment of the present invention is directed to a system for medical device safety notification. According to such an embodiment, the system includes a complaint database that is configured to receive and store indications of received medical device complaints where each complaint includes a respective UDI of the corresponding medical device. Further, such an embodiment of the system includes a manufacturer module which is configured to automatically notify a respective manufacturer for each received medical device complaint. Further still, the system comprises a safety notification module that is configured to generate and send safety notifications about the corresponding medical device in response to receiving instructions from the respective manufacturer.

According to an embodiment of the system, the medical device complaints are received from at least one of a patient, a hospital, a health care provider, and a complaint database. In yet another embodiment, the system is configured to send the safety notifications in a HIPPA compliant manner. The safety notification module is further configured to automatically send the safety notifications to at least one of a patient, a hospital, a health care provider, and a regulatory body, in an embodiment of the present invention.

According to an embodiment of the system, the safety notification module is configured to automatically send the safety notifications via at least one of SMS text message, e-mail, letter, facsimile, and phone. In an alternative embodiment, the system is further configured to determine acknowledgment status of sent safety notifications. In yet another embodiment, the safety notification module is further configured to determine recipients of the safety notifications. In such an embodiment, the safety notification module may be configured to determine the recipients using a database of UDIs. In an alternative embodiment, the safety notification module is further configured to send notifications based upon respective preferences of the recipients.

Another embodiment of the present invention is directed to a cloud computing implementation for medical device safety notification. Such an embodiment is directed to a computer program product executed by a server in communication across a network with one or more clients, the computer program product comprising a computer readable medium. The computer readable medium comprises instructions which, when executed by a processor causes the processor to receive medical device complaints and store indications of the received medical device complaints in memory coupled to the processor, wherein each complaint includes a respective UDI of a corresponding medical device. The instructions also cause the processor to automatically notify a respective manufacturer of the corresponding medical device for each received medical device complaint, and in response to receiving instructions from the respective manufacturer, to generate and send safety notifications about the corresponding medical device. The processor may be configured to send the safety notifications on behalf of the manufacturer or other party.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a table listing medical devices and respective users that may be utilized in embodiments of the present invention.

FIG. 2 is a flow diagram of a method for bar code medication administration.

FIG. 3 is flowchart of a method for medical device safety notification according to an embodiment.

FIG. 4 depicts a UDI that may be employed in embodiments.

FIG. 5 is a table listing attributes of UDIs that may be employed in embodiments of the present invention.

FIG. 6 illustrates example UDIs and UDI placement on medical devices.

FIG. 7 is a flow diagram depicting methods for medical device safety monitoring and notification according to embodiments.

FIG. 8 illustrates a system for medical device safety notification and the flow of data therein according to an embodiment of the present invention.

FIG. 9 is a diagram of healthcare facility event recording and submission to medical device manufacturers according to an embodiment.

FIG. 10 depicts a method for healthcare facility event recording and submission to medical device manufacturers according to principles of an embodiment.

FIG. 11 portrays a method of event recording at a physician's office and submission to a medical device manufacturer that may be employed in an embodiment.

FIG. 12 is a method of event reporting and submission to manufacturers according to the principles of the present invention.

FIG. 13 depicts adverse event reporting to the FDA and a medical device manufacturer that may be implemented in an embodiment.

FIG. 14 illustrates example methods of sending medical device safety notifications that may be utilized in embodiments.

FIG. 15 is an example safety device notification and acknowledgement log that may be generated by embodiments of the present invention.

FIG. 16 is a simplified block diagram of a system for medical device safety notification according to principles of an embodiment.

FIG. 17 is a simplified diagram of a computer network environment in which an embodiment of the present invention may be implemented.

### DETAILED DESCRIPTION OF THE INVENTION

A description of example embodiments of the invention follows.

The teachings of all patents, published applications, and references cited herein are incorporated by reference in their entirety.

Embodiments of the present invention provide notifications to patients and end users of medical devices for product issues that arise which require effective and timely notification of the medical device issues to the registered owners/users of the medical devices. Product issues can be identified (1) internally within the medical device manufacturing company, (2) by end users of the medical product within a healthcare facility, and/or (3) by patients, amongst other examples. Registered owners/users who receive these safety notifications include but are not limited to hospitals, ambulatory surgical facilities, outpatient diagnostic facilities, outpatient treatment facilities, nursing homes, physician offices, patients, and any other facility providing patient care.

Embodiments also manage the complete product notification process. From the (a) reporting person/healthcare facility of the medical device anomaly/incidence, (b) communication of the anomaly/issues from the reporting person/facility to the medical device manufacturer, (c) from the medical device manufacturer to the registered owners and end users of effected medical devices (i.e., patient and end users of medical devices such as hospitals, healthcare facilities, physician offices) in a timely and effective manner via SMS text messaging, email, and postal mail, etc. These notifications are critical to the safe and effective operation and use of the medical device, ensuring both patient and end user safety. Furthermore, embodiments can also implement timely notification of adverse events to regulatory bodies such as the FDA MedWatch System.

While solutions exist for providing safety notifications, these existing solutions need to be improved. One of the main problems effecting medical device companies and their impact upon patient safety is the effective and timely notification of end users of medical devices for which there is an issue and/or a notification regarding the operation and/or use of the medical device that requires immediate attention. Moreover, existing solutions do not provide verification acknowledgement that the sent notification has been received and read. These notifications can be precautionary, e.g. in regards to application and use of the product, which does not affect patient safety or related to product recall notifications informing end users to stop using the product due to impact upon end user and/or patient safety.

When employing existing solutions, too much time elapses between the identification of a product issue and the notification of effected end users of the product with verification acknowledgement that the notification has been received and read. Further, these delays and/or failures to notify end users often result in the FDA issuing citations to the medical device companies.

Medical device companies also have difficulty identifying the effected medical device models and manufacturing production lots. Geo-global manufacturers are especially sensitive to these problems because manufacturing of the same product/model may be distributed globally amongst numerous manufacturing facilities. Thus, even after completing a root cause analysis where the effected fault has been identified, it is still a very time consuming effort to identify the manufacturing facility where the product was built and the effected production lot run. Even after identifying the manufacturing facility and the production lot run, it is still a laborious task to determine the registered owners of the devices and send out field notifications.

In addition to the aforementioned difficulties, healthcare facilities also lack the necessary methods to easily notify medical device manufacturers of medical device issues. Healthcare institutions and private physician offices cannot properly, effectively, and timely communicate patient issues associated with the application and use of a medical device to the manufacturer of the product. Presently, many healthcare facilities rely on a paper based reporting system for sending notifications of device and/or user issues from the healthcare facility to the medical device company. Often these paper based records do not contain all of the proper identification information about the effected medical device (i.e., model number, serial number). Further, very often there is a delay in time between the recordings of the event at the healthcare facilities and the time that a notification is sent to the manufacturer.

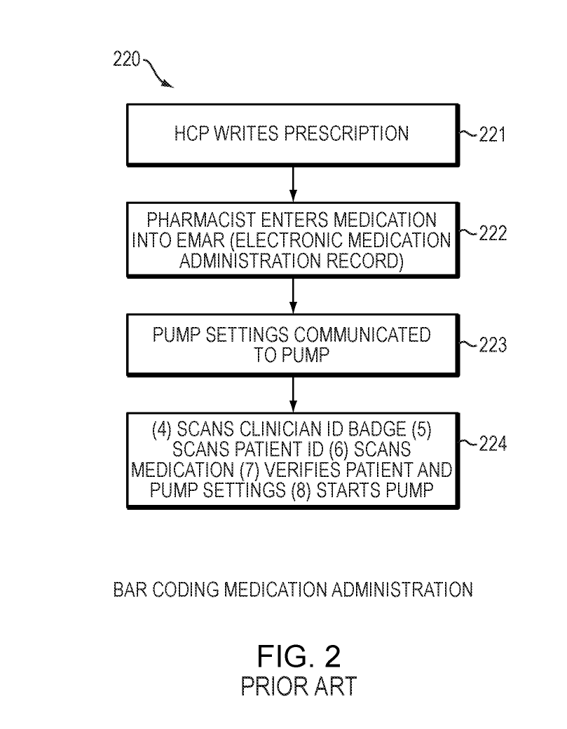

Moreover, while some hospitals use electronic health care record systems these systems do not contain the medical device to patient information link data that is necessary for sending notifications. There is an existing product, of which a flow chart 220 is illustrated in FIG. 2 which links the physician order 221, to the pharmacy drug dose system 222, to the IV pump 223, to the attending nurse who is administering the medication 224 to the patient all through a bar code system by following the steps 4-8 of the step 224 in the flow chart 220. This method 220 does link an electronic medication administration record 222 with the pump 223, but fails to provide any functionality for issue notification and manufacturer communication.

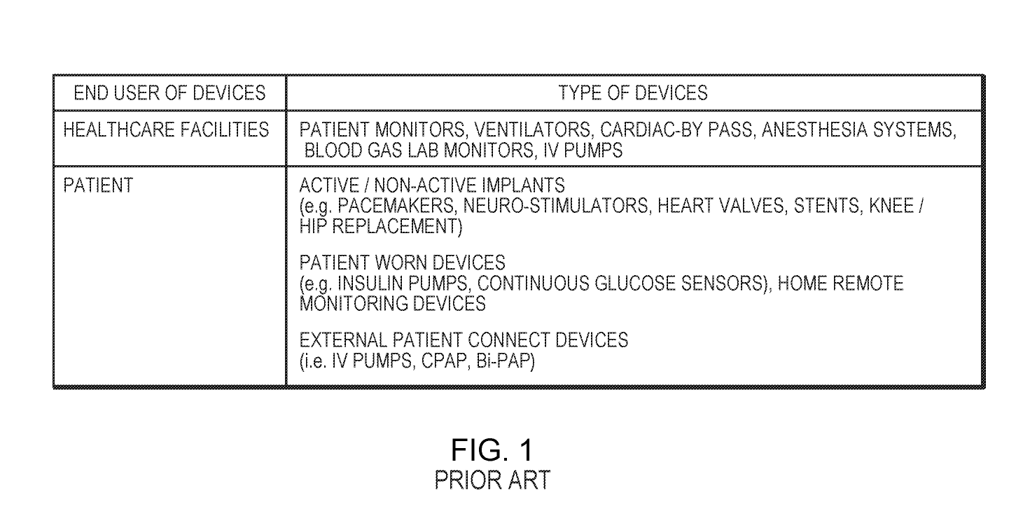

Notifying patients who are utilizing implantable, wearable, or on-body medical devices is often extremely difficult. Many patients with implantable devices and other worn devices, some of which are listed in FIG. 1, are sometimes lost to follow up. A large portion of patients with implantable/patient wearable devices (i.e., pacemakers, defibrillators, neuro-stimulators), non-active implantable devices (i.e., heart valves, stents, knee/hip implants), and/or patient wearable devices (i.e., insulin pumps, continuous glucose sensors) cannot be notified of medical device safety notifications using existing techniques. The healthcare professional (i.e., physician) patient relationship is often momentary and brief. Primary care physicians are often unable to give relevant device safety or efficacy information (i.e., ambulatory status, pain with motion) to the patient. Longitudinal device tracking for safety and efficacy is very difficult and reporting ad hoc.

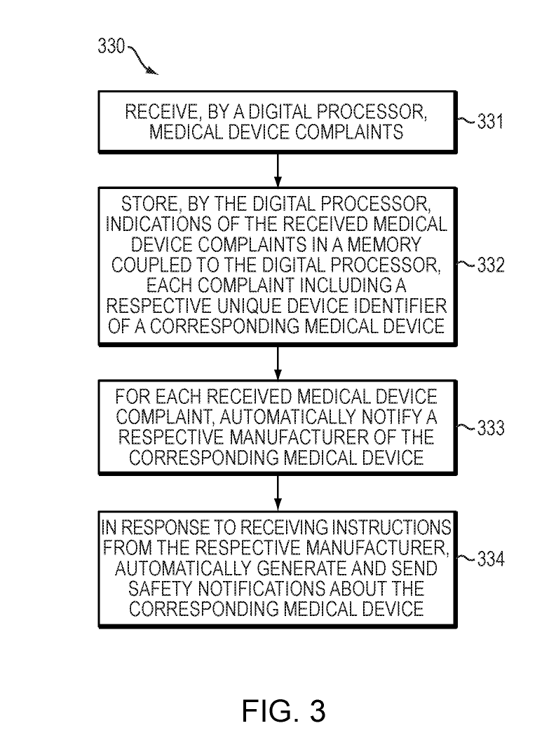

Embodiments of the present invention overcome the aforementioned deficiencies of existing notification systems. FIG. 3 is a flow diagram of a method 330 for medical device safety notification. The method 330 begins by receiving, by a digital processor, medical device complaints (331). According to an embodiment of the method 330, the medical device complaints may be received via any communication means known in the art, for example via a wireless area network (WAN) and/or local area network (LAN). The method 330 continues by storing indications of the received medical device complaints in a memory coupled to the digital processor (332). According to such an embodiment of the method 330, each complaint includes a respective UDI of the corresponding medical device. Further, the medical device complaints may be stored in any memory medium that is known in the art. After storing the medical device complaints (332), the method 330 continues by automatically notifying a respective manufacturer of the corresponding medical device for each received medical device complaint (333). The notifications may be sent to the manufacturers via any communication means known in the art. The method 330 concludes by automatically generating and sending safety notifications about the corresponding medical device in response to receiving instructions from the respective manufacturer (334). The safety notifications are automatically sent on behalf of the manufacturer, or other (third) party.

According to an embodiment of the method 330, the medical device complaints are received from at least one of: a patient, a hospital, a health care provider, and a complaint database. Further, in embodiments of the method 330, the medical device complaints may be received from any person or place that utilizes medical devices. According to an embodiment of the method 330, the safety notifications may be set in a HIPPA compliant manner. For example, the notifications may be sent to patients without including personally identifying information and/or in an encrypted manner. Further still, embodiments of the method 330 may send safety notifications to any people or places that are affected by medical device safety, including, patients, hospitals, health care providers, and/or regulatory bodies. The method 330 may send safety notifications via any means known in the art. For example, medical device safety notifications may be sent via SMS text message, e-mail, letter, facsimile, and/or phone.

Embodiments of the method 330 further include determining acknowledgment status of the sent safety notifications. These acknowledgments may be communicated via any means known in the art. The method 330 may further include determining recipients of the safety notifications. In such an embodiment of the method 330, the recipients may be determined using a database of UDIs. Further still, the recipients may be determined by utilizing a sales database or registry. According to an embodiment, the method 330 may send the safety notifications based upon respective preferences of the recipients. In such an embodiment, recipients may elect a preferred communication means upon purchasing a medical device.

Embodiments of the present invention leverage the Unique Device Identifier (UDI) which is required for all Class I, II, and III medical devices sold in the United States. It should be noted that other countries are in the process of implementing a UDI (e.g. Europe, China, Canada, Japan), and embodiments of the invention described herein can be implemented globally. The UDI was created to address patient safety. Benefits of the UDI include but are not limited to: (1) improving patient safety through faster recall notification; (2) allowing medical device manufacturers, distributors, and healthcare facilities to more effectively manage medical device recalls through use of a standardized identifier; (3) more accurate reporting, reviewing, and analysis of adverse event reports so that problem devices can be identified and corrected more quickly; (4) reduction in medical errors by enabling health care professionals and others to more rapidly and precisely identify a device and obtain important information concerning the characteristics of the device; (5) more robust post-market surveillance system; and (6) more efficient ways to address new concerns raised in premarket submission.

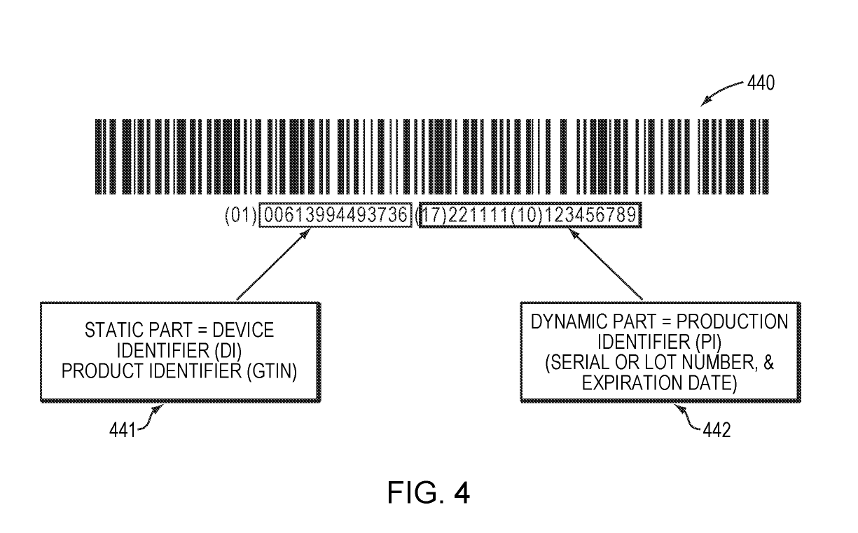

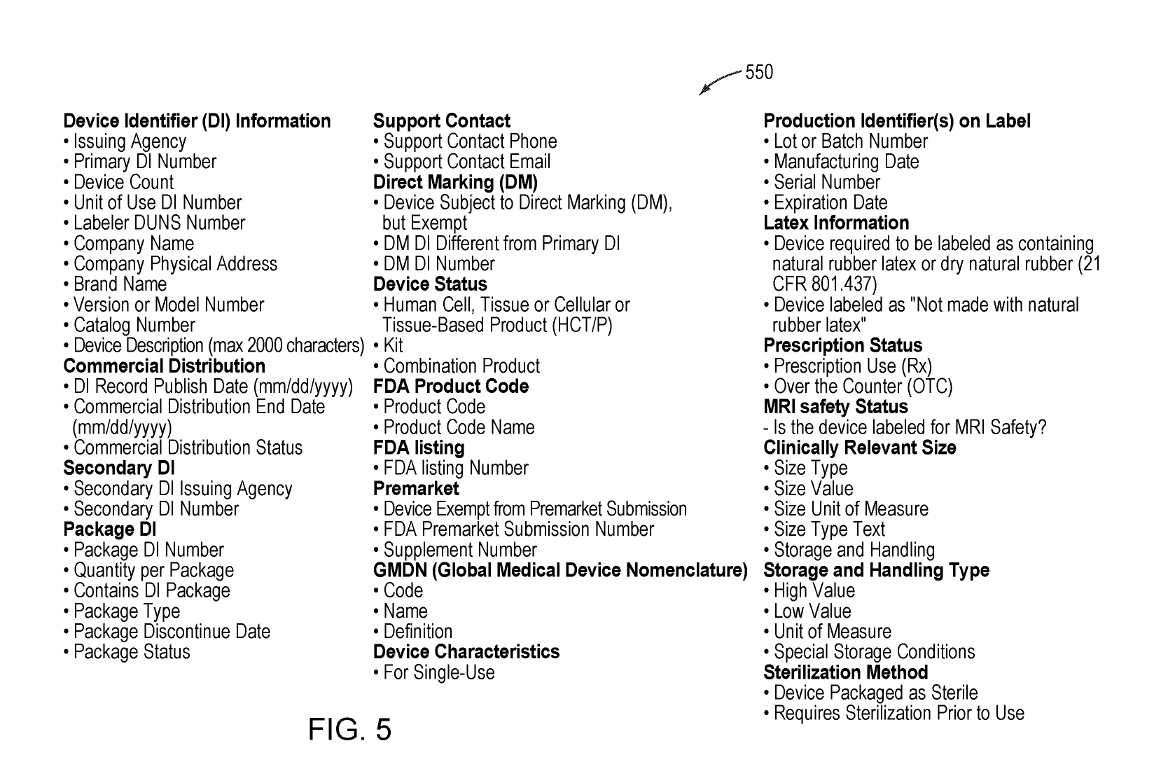

An example UDI 440 is illustrated in FIG. 4. The UDI 440 is comprised of a device identifier 441 and a production identifier 442. The device identifier 441 identifies a specific version, model, and/or model number of the medical device through its distribution and use. The production identifier 442 contains manufacturing and production information, e.g., lot number, batch number, serial number, expiration date, and/or manufactured date. Additional attributes 550 of the UDI are listed in FIG. 5.

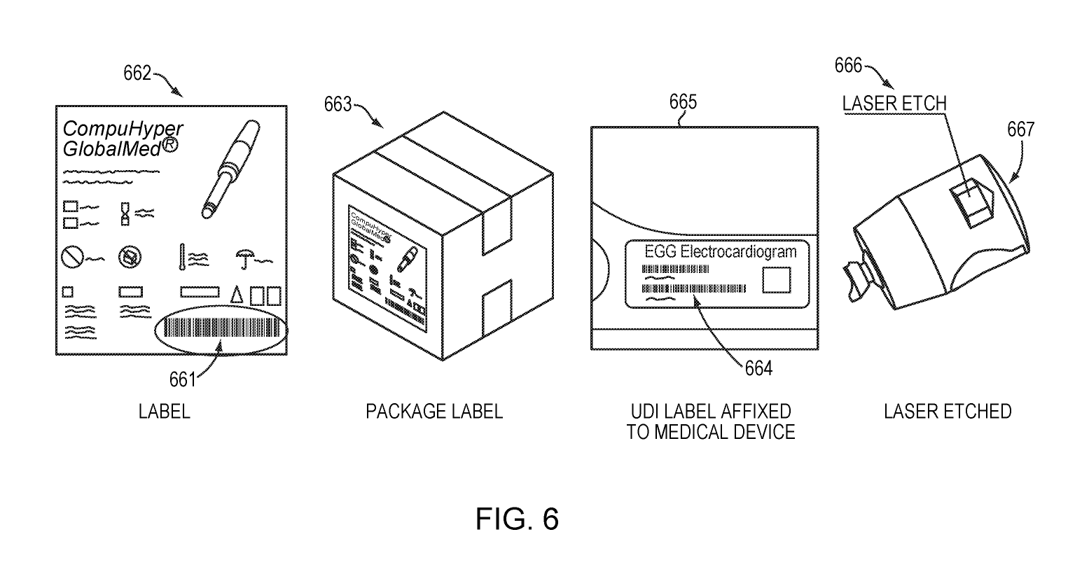

FIG. 6 depicts various ways in which a UDI can be associated with a medical device. In FIG. 6 the UDI 661 is printed on a label 662. The label 662 can in turn be affixed to product packaging 663. A UDI can also be on the medical device itself. For example, the UDI label 664 is directly affixed to the medical device 665 and the UDI 666 is laser etched directly on the medical device 667.

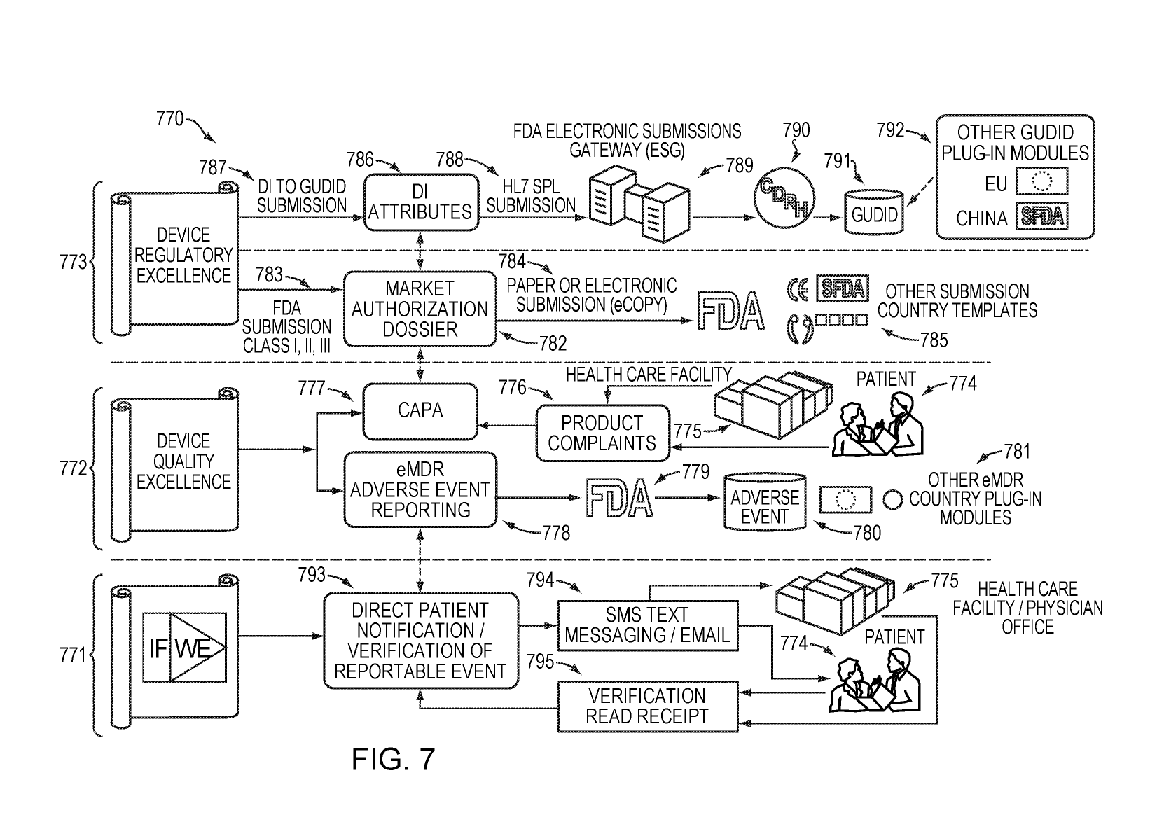

Embodiments of the present invention can be implemented as standalone applications or can interface with other systems to form a holistic integrated complaint management notification system. One such integrated system 770 is shown in FIG. 7. The system 770 includes the patient notification process 771, device quality excellence process 772, and device regulatory excellence process 773. The processes 771, 772, and 773 work in conjunction to provide an integrated complaint management and notification system.

The system 770 relies upon receiving complaints from one or more health care facilities 775 and one or more patients 774, which are received at the product complaints module 776. The product complaints 776 are then provided to the CAPA 777 which in turn provides the complaints to the eMDR adverse event reporting module 778. The adverse event reporting module 778 notifies the regulatory body, such as the FDA 779 which can store the adverse events in the storage 780 from which other countries can be notified of the adverse events through use of other eMDR Country plug-in modules 781. Upon identification and validation of the root cause, information can be linked to the creation of an adverse event report which is electronically submitted to the FDA 779. The submission of the medical device report to the FDA 779 can be accomplished through the Device Quality Excellence Industry process solution 772.

As described above, the CAPA module 777 receives the product complaints 776. The CAPA module 777 can then forward the complaints 776 to the market authorization dossier module 782. The market authorization dossier module 782 can include the complaints along with FDA submission Class I, II, and III documentation 783 to form the paper or electronic submissions 784 which can be sent to one or more regulatory bodies 785. The market authorization dossier module 782 can further provide the complaints 776 to the device identifier (DI) attributes module 786. The DI attributes module 786 can incorporate the DI attributes with the Global Unique Device Identification Database (GUDID) submission data 787 and the complaints 776 to form the HL7 SPL submission 788 which can be provided to the FDA electronic submission gateway 789. The FDA gateway 789 can in turn provide this information to the Center for Devices and Radiological Health 790 which can store the information, including the complaints 776 in the GUDID 791. Other countries and territories can in turn access the GUDID 791 by utilizing plug-in modules 792.

The above described processes 772 and 773 provide notification of complaints to regulatory bodies. The notification/verification process 771 notifies patient(s) 774 and health care facilities/physician office(s) 775 of the complaints 776. In the process 771, the direct patient notification/verification module 793 receives the product complaints 776 from the eMDR adverse reporting event module 778. The notification/verification module 793 then determines patients and/or facilities that need to be sent notifications. Notifications 794 are in turn automatically generated in the form of emails and/or SMS text messages, for example, and then sent to the identified patients 774 and facilities/offices 775. The patients 774 and facilities/offices 775 send a read receipt 795 to the notification/verification module 793, thus completing the notification and verification process 771.

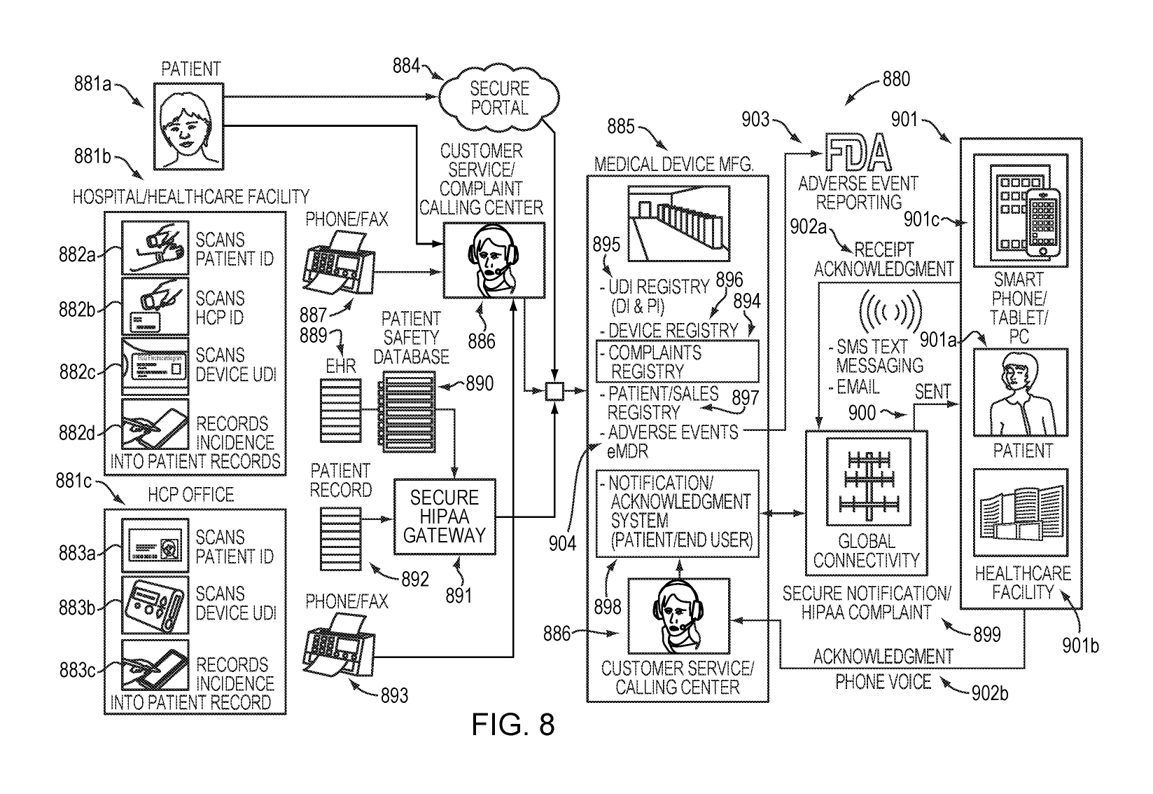

FIG. 8 illustrates an overview of a notification process 880 according to an embodiment of the present invention. In the process 880 medical device complaints can be collected from patients 881a, hospitals 881b, and health care provider offices 881c. The patient 881a can provide a complaint to the manufacturer 885 through direct communication via the secure portal 884. Alternatively, the patient 881a can provide complaints by contacting a call center 886 that can in turn provide the information to the manufacturer 885.

A hospital 881b can also provide patient complaints to the manufacturer 885. The hospital 881b can communicate complaints to the call center 886 using phone/fax 887. Alternatively, the hospital may employ electronic health records (EHR) 889 which can be used to facilitate complaint communication. In such an example, a complaint is communicated from the electronic health records database 889 to a patient safety database 890. The complaint is then forwarded from the patient safety database 890 via the secure Health Information Portability and Accountability of Act (HIPAA) gateway 891 to the manufacturer 885. The hospital 881b may follow a standardized procedure to record medical device complaints. The procedure may begin by scanning patient identification, such as a hospital bracelet 882a. Next, a health care provider scans the healthcare provider identification, 882b, and the medical device UDI 882c. This process has then identified the effected patient, where the complaint is coming from, and the device associated with the complaint. The provider then records the complaint in the patient record 882d. Once the complaint is recorded into the patient record 882d, it can be provided to the manufacturer as described hereinabove.

The process 880 also allows health care provider offices 881c to communicate complaints to the manufacturer 885. One methodology the health care provider 881c can use to send complaints to the manufacturer 885 is to send complaints from a patient records database 892 to the manufacturer 885 via the secure HIPPA gateway 891. Alternatively, the health care provider 881c can communicate complaints to the call center 886 using telephone/facsimile 893. Similarly to the hospital 881b, the health care provider office 881c can also follow a standardized procedure to record and send complaints. Such a procedure begins with scanning patient identification 883a. Next, the device UDI is scanned 883b and the complaint is recorded into the patient record 883c. In turn, the complaint is communicated via phone/facsimile 893 or from the patient records database 892 as described hereinabove.

Described hereinabove are the various methodologies that may be employed in the process 880 to communicate complaints from effected users to the manufacturer 885. Once the manufacturer 885 is in receipt of the complaints, the manufacturer 885 stores the complaints in the complaints registry 894. For example, in the case of electronically communicated complaints, e.g. email, the complaints can be electronically stored in the complaints registry database 894. Complaints received via fax can be manually entered into the registry 894 and/or converted into a PDF file and saved to the complaints registry 894. Voice call complaints can be manually entered into the complaints registry 894 by the customer service/complaint call center 886 personnel. The complaints registry 894 may be any storage means known in the art.

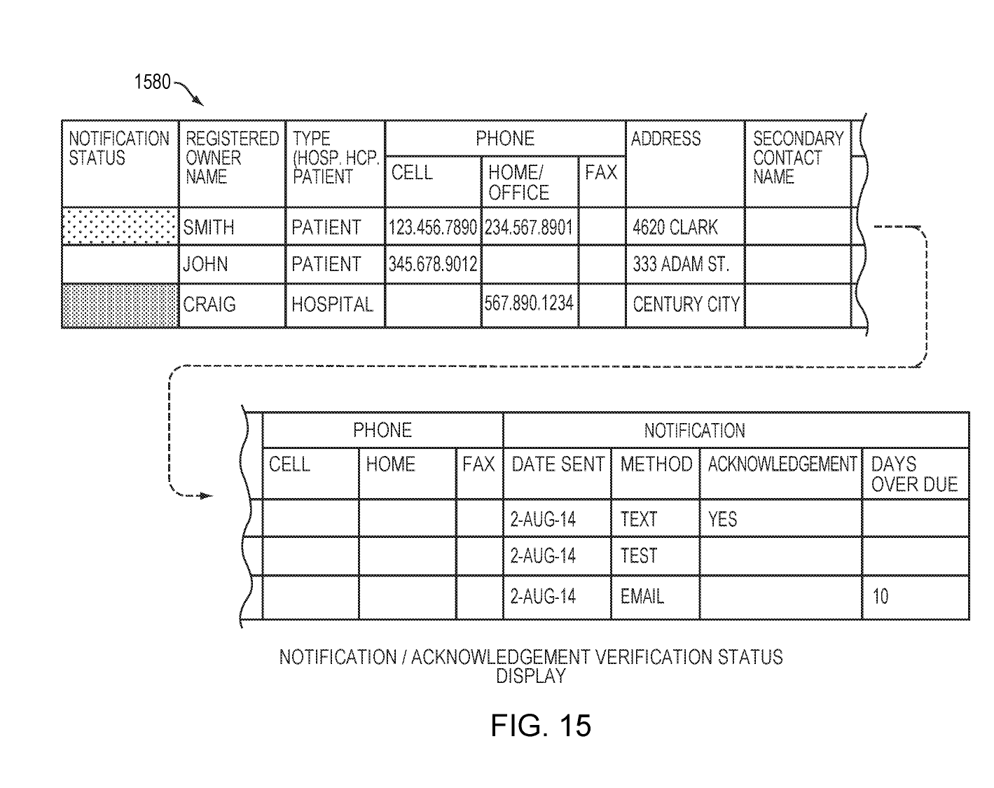

After receiving complaints the manufacturer 885 can open an investigation of the reported incident(s) to determine the impact on patient safety. The problem/cause can be identified and if the manufacturer 885 determines the problem to be patient safety related, a CAPA can be opened where the reported issues can be analyzed in more detail. For example, a failure analysis and root cause analysis can be performed and product design changes and/or manufacturing process changes can be identified. Analysis can also be non-product design/manufacturer related and can be associated with the use of the medical device, i.e. changes to the product instruction user guide. Upon determining that an end user safety notification message is needed, it must then be determined who should receive notifications. In the system 880, the notification acknowledgement system 898 utilizes the UDI registry 895, device registry 896, and/or patient sales registry 897 to determine patients, hospitals, and health care provider offices that should receive safety notifications. For example, the device manufacturer 885 can access the UDI database 895 to quickly identify via the device identifier and production identifier where the product is manufactured, impacted production lots, and serial numbers. The production identifier information is linked to the patient and sales registry 897 which contains a database of the sold medical device products by product type, model number, software version (if applicable), who the product was sold to (i.e., hospital, dealer, patient), date of sale, contact information, etc. and applied UDI code. This allows for the quick identification of all registered owners of the effected device. This list of intended notification recipients can also be stored and accessed for cross reference review by a user. Further, the list can be employed to create a notification and acknowledgment log as shown in FIG. 15 and described below.

After determining recipients, the manufacturer 885 utilizes the notification system 898 to generate and send the notifications via the secure gateway 899 to the recipients 901. In an example embodiment, the notification system 898 may provide a data entry field to a user to enter the notification message. The secure gateway 899 may send 900 the messages using any communication technique known in the art. For example, notifications may be sent using SMS text messages and email. The recipients 901 may be patients 901a and/or healthcare facilities 901b, for example, and may receive the notifications via smart phone, tablet, or computer 901c. These computing devices 901c are non-limiting examples, and recipients 901 may receive the notifications through any communication means known in the art. Notifications sent via SMS text message and email can be sent in compliance with HIPAA standards and data encryption to the extent required. The system 880 can also facilitate end user downloads of an encryption application onto respective electronic devices (e.g., smartphone and tablet 901c) that provides for point-to-point encryption of SMS text messages and email notifications. Notification messages can also be sent via postal service. For such messages, the system 880 can be communicatively coupled to a label maker for printing the appropriate recipient address labels and/or be coupled directly or via a network, to a printer that can print contact information directly onto envelopes. The messages themselves can also be printed via the aforementioned printing methods. Once the notification messages are sent, the aforementioned notification/acknowledgment log can be updated to include the method and date the notification messages were sent. The method by which messages are sent can be defined at the time of selling the medical device and this information can be stored in the patient/sales registry 897. Recipients can also select an alternative notification method as well.

The recipients 901, in turn provide acknowledgement 902a and/or 902b of the received safety notifications. The acknowledgment 902a is provided to the manufacture 885 via the gateway 899. For example, the patient 881a can provide confirmation of the received notification via text message or email. The acknowledgment 902b is sent by the recipient 901 by placing a phone call to the call center 886. The acknowledgements 902a and 902b can then be stored by the manufacturer 885 in the notification/acknowledgement system 898, thus providing a record of sent notifications and received corresponding acknowledgments.

The notification acknowledgment system 898 further allows the manufacturer 885 to set a time delay, upon which, if the notified person has not sent back an acknowledgement, the system will automatically notify the manufacturer 885 of intended recipients that have not sent back acknowledgments. The notification system 898 can in turn automatically send out another notification via text, email, or postal mail as described herein.

The system 880 further facilitates notifying regulatory bodies, such as the FDA 903 of medical device complaints. This is accomplished by using an adverse event eMDR 904 which communicates the complaints to the regulatory body 903.

While the system 880 is illustrated as a standalone system, the system 880 can also be incorporated into existing device management applications. The system 880 provides numerous benefits to patients and care providers alike. Healthcare facilities can quickly capture the UDI for any effected medical device and patient implantable medical device (i.e. pacemaker, knee implant) and record the data into the patient electronic health record and/or a device complaint registry. Further, the system 880 allows healthcare facilities and physician offices to efficiently and quickly send the observed device related issue and associated device UDI to the manufacturer's device complaint registry via electronic gateway and/or can send the information via fax and/or phone. Manufacturers in turn can quickly identify associated manufacturing facilities and production lot numbers and patients/end users that need to be notified through the product identifier and/or the Patient and/or Sales Registry. Further still, the system 880 allows patients to easily notify medical device manufacturers of observed events via smartphone, tablet, and PC. Unlike existing methodologies, the system 880 allows manufacturers to receive confirmation notification that the patient, end user, HCP, dealer, has received and read the notification within a specified time after sending the notification. The system also provides the ability to notify secondary family members or care takers. More efficient identification of the specific medical device at issue (user and/or patient related) and entry into the patient electronic health record (EHR) is also facilitated by the system 880. Scanning of the device UDI code, which is provided by the system 880, allows easy entry of the device information into the EHR. Upon being made aware of medical device complaints, the system 880 provides a more efficient notification of the recorded medical device event to the medical device manufacturer via electronic communication with receipt verification from the medical device manufacturer that the reported anomaly event has been received by the medical device company. For the primary healthcare provider (i.e., physician), more efficient identification of the prescribed medical device UDI and links to the patient EHR is facilitated by the system 880. Medical device manufacturers can quickly identify, through the UDI device code, the product, model, and serial number of the reported device. Upon identification of a root cause, the manufacturing facility or third party supplier, affected manufacturing lots, and associated serial numbers via the UDI Device Identifier (DI) and associated Production Identifier (PI) can be quickly identified. Upon identification of lot batch production run serial numbers, the system can link to the patient sales registry and/or sales registry thereby identifying by model and serial numbers all of the registered owners for the medical device for which notification letters need to be sent out (i.e., healthcare facilities, healthcare professionals (i.e., physicians), patients, third party medical device distributors, consumers and retail stores/pharmacies). The system provides the ability for the medical device company to create several different notification letters depending upon who the registered owner is (i.e., patient, healthcare institution) and the method by which the notification message is to be sent while being in compliance with the HIPAA standards for protecting health information (e.g., names, addresses, health information, records).

The system 880 provides advantages over existing notification systems. The system 880 in general provides efficient, effective, and accurate methods of performing medical device safety notifications. Unlike existing systems, the system 880 records the observed device event, medical device ID information via the UDI bar code/human readable text, patient information, and reporting person (i.e., clinician, biomed-tech, or patient) at the time of occurrence or shortly thereafter. In turn, the system 880 facilitates efficient reporting/sending of the device anomaly information to (1) the medical device manufacturer including information about the medical device through the use of the UDI bar code, and/or (2) the user who observed the event (i.e., healthcare provider such as nurse, physician, and clinician or the patient). The system can also report an adverse event directly to the FDA and the medical device manufacturer. The system 880 provides an improved ability for the medical device manufacturer to be more effective in the logging of reported issues or adverse events with all of the pertinent information relating to the reported issues (i.e., healthcare facility name and/or contact information, description of reported event, time of occurrence, patient information, medical device information via UDI, etc.). Because of the improved logging/recordation of complaints, the medical device manufacturer is able to review all of recorded events by product model name and/or model number as provided by the UDI. In turn, this allows the medical device manufacturer to quickly identify: the manufacturing operation responsible for manufacturing the product, the affected manufacturing batch or lot production runs, the associated serial numbers, and the registered owners of the effected medical devices through the serial numbers and the sales or patient registry. This also helps the manufacturer to (1) be timelier in sending out adverse event notifications to the regulatory body (i.e. U.S. FDA) and to registered owners of the medical device; (2) track the status of all reported events by product (i.e., in review, open under investigation, root cause identified, work in process, closed events, number of events by classification type (i.e., user or operator error, device malfunction, patient safety); (3) be more efficient in sending out notification messages to registered owners of effected medical devices informing them to either contact the medical device manufacturer for more information of their product and or provide a link which will direct the end user to the manufacturer site where they can read and or download the information notice about their device; (4) track the overall status of notification messages sent to all registered owners; (5) track those that have responded to the notifications messages and those that have not responded to the notification messages; (6) send secondary and tertiary notification messages to registered owners to the extent possible and keep track of all sent and received acknowledgement messages; (7) more efficiently ensure that the notified registered owners have received their product notification bulletins via website download, email, and standard postal mail thereby ensuring compliance with reporting standards and ensuring patient safety; and (8) ensure that all effected medical device products have been corrected for.

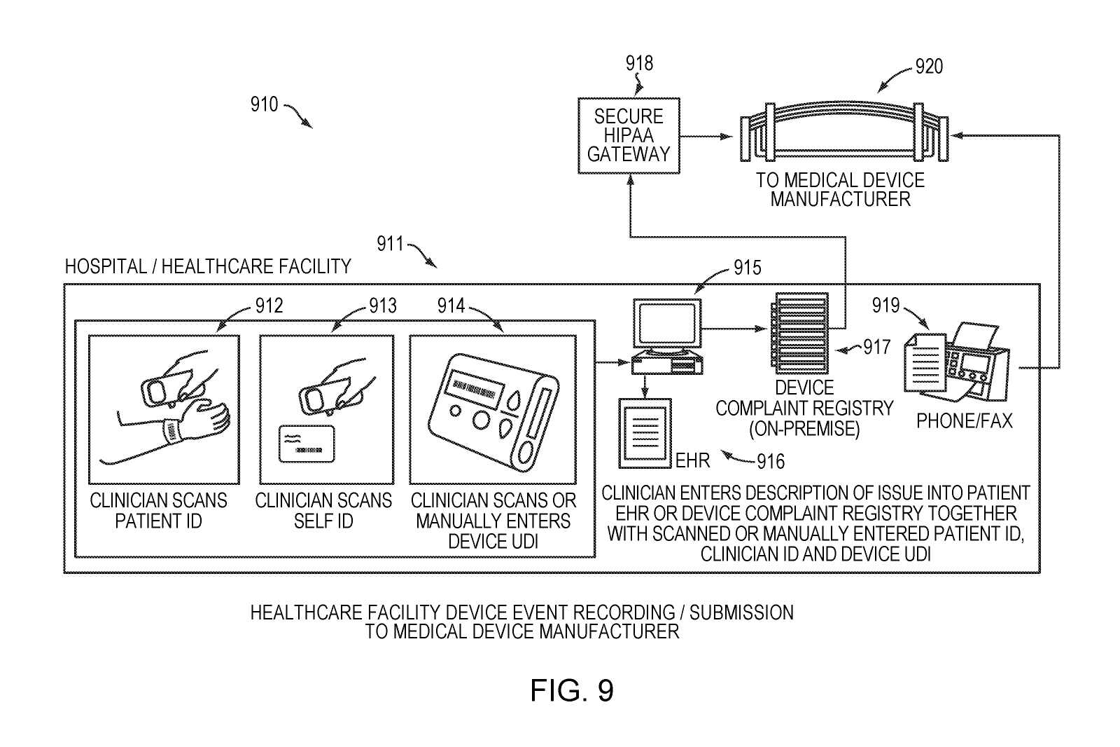

FIG. 9 depicts a process 910 that may be used in embodiments of the present invention to record complaints at a healthcare facility 911 and report the complaints to a medical device manufacturer 920. In the process 910 a clinician first scans a patient's identification, e.g., hospital bracelet 912. The clinician then scans his or her own ID 913 and then scans or manually enters the device UDI 914. The clinician via computing device 915 then enters a description of the medical device complaint into the patient electronic health records 916 and/or the on-site device complaint registry 917, which both store the complaint along with the patient ID, clinician ID, and device UDI. This data can then be sent from the health records database 916 and/or device complaints registry 917 to the manufacturer 920. The complaints can be sent to the manufacturer 920 using phone/facsimile 919 and/or through a communications network, such as the internet, via a secure HIPAA gateway 918.

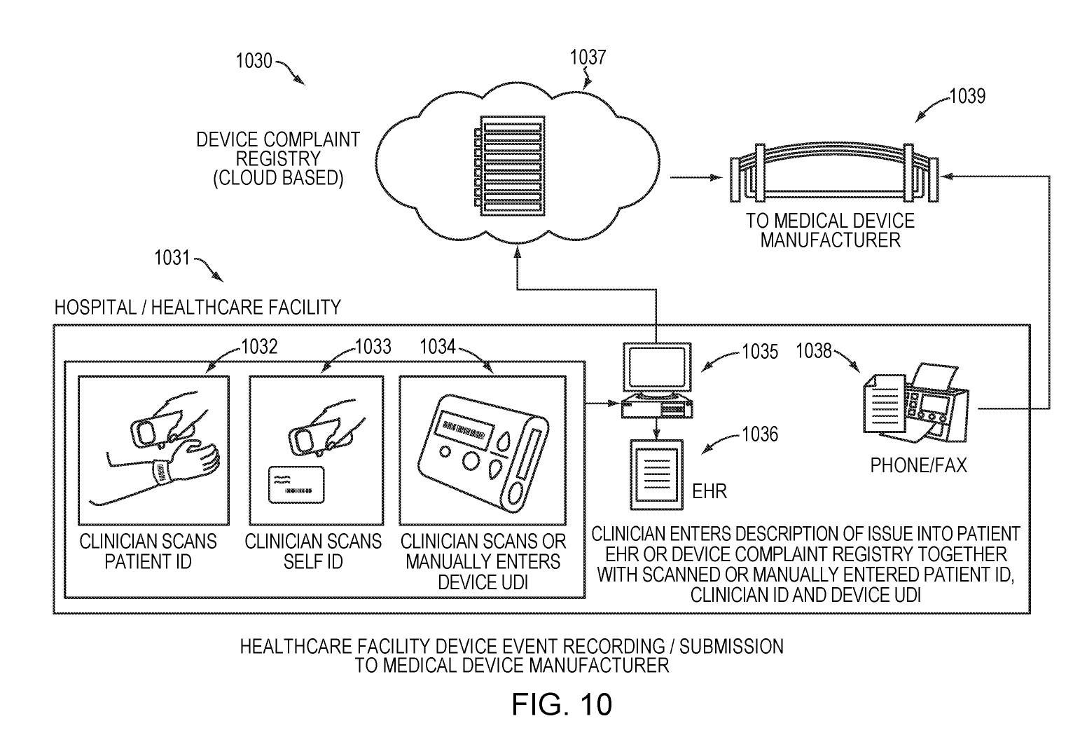

FIG. 10 illustrates a process 1030 that may be used in embodiments of the present invention for recording complaints at a healthcare facility 1031 and reporting the complaints to a medical device manufacturer 1039. The process of recording a complaint begins with a clinician scanning the patient's ID 1032. The clinician then scans his or her own ID 1033 and scans or manually enters the device UDI 1034. The clinician via processor 1035 then enters a description of the medical device complaint into the patient electronic health records 1036 and/or the cloud based complaint registry 1037. In this embodiment, both the electronic health records 1036 and the cloud based complaint registry 1037 store the complaint along with the patient ID, clinician ID, and device UDI. The complaints are then sent to the manufacturer 1039 using phone/facsimile 1038 and/or from the cloud based complaint registry 1037 through a communications network, such as the internet. Optionally, complaints may be sent from the electronic health records database 1036 to the manufacturer 1039 through a communications network, such as a WAN (not shown).

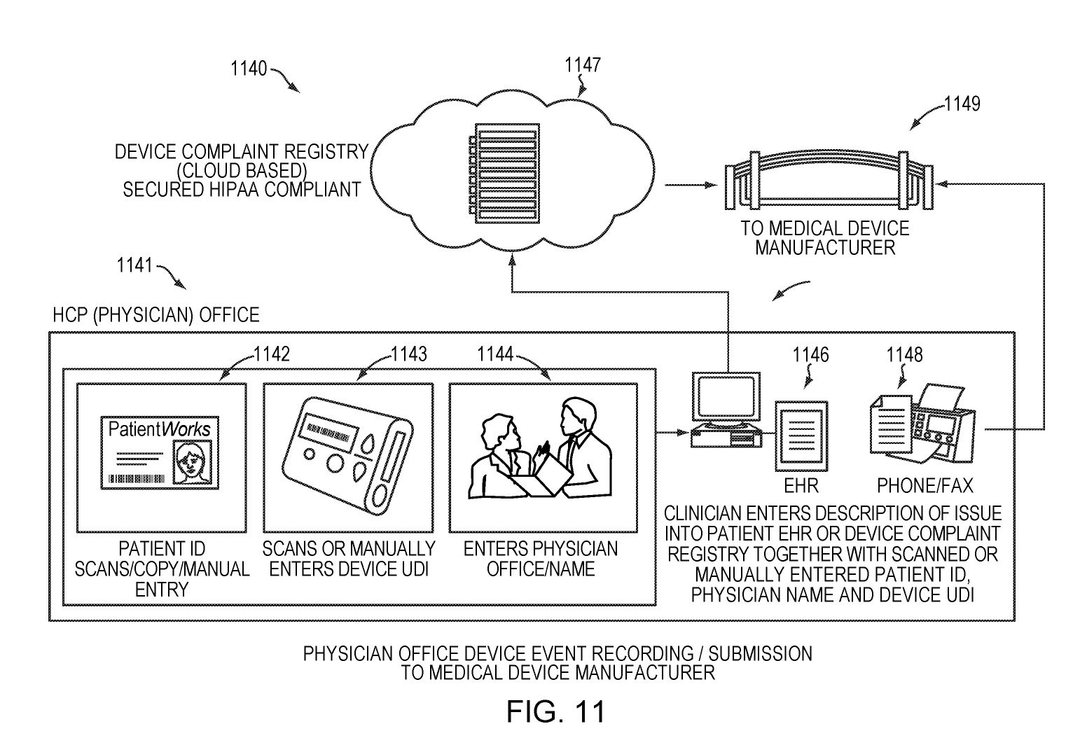

FIG. 11 is a simplified diagram of a method 1140 that may be used in embodiments of the present invention to record complaints at a healthcare provider's office 1141 and in turn report the complaints to a medical device manufacturer 1149. To begin, the patient's ID is either scanned, copied, or manually entered 1142. The clinician then scans or manually enters the device UDI 1143. The data collection steps 1142 and 1143 may be performed before the patient is seen by the doctor. Once the physician sees the patient 1144, the physician enters a description of the medical device complaint into the patient electronic health records 1146 and/or the cloud based complaint registry 1147. In this embodiment, both the electronic health records 1146 and cloud based complaint registry 1147 store the complaint along with the patient ID, clinician ID, and device UDI. In the process 1140 the physician may enter the data into the database(s) 1146 and 1147 through any means (1145) known in the art. For example, by utilizing the computing device 1145. After the complaints are stored, the complaints can be sent to the manufacturer 1149 using phone/facsimile 1148 and/or from the cloud based complaint registry 1147 through a communications network, such as the internet.

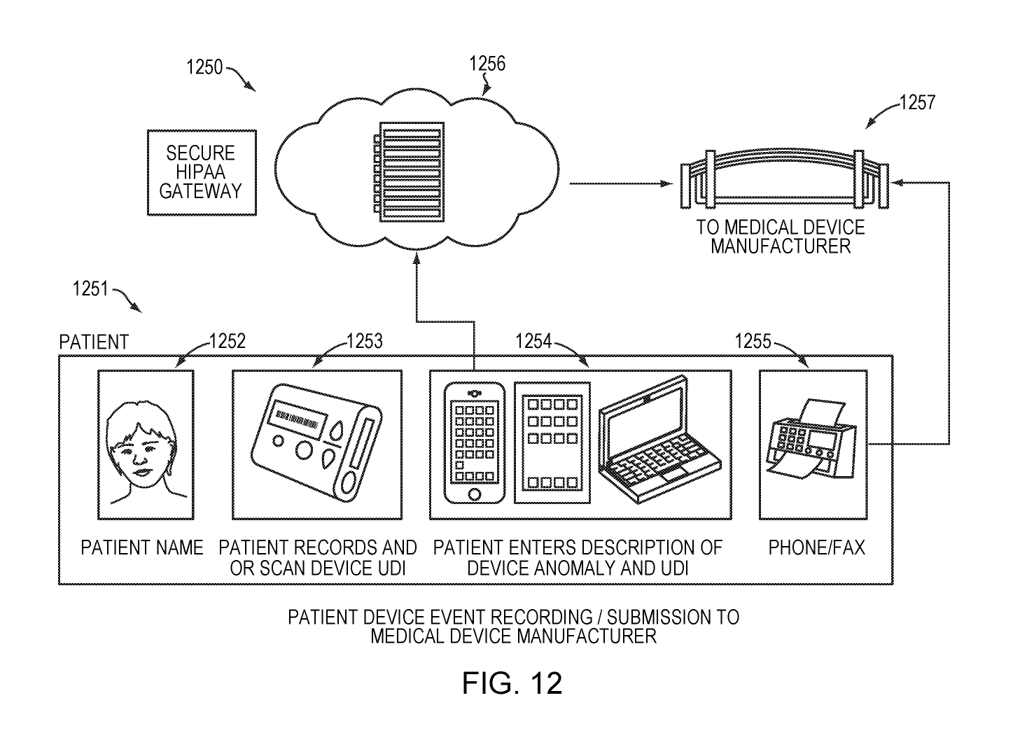

FIG. 12 is a process 1250 that may be used in embodiments of the present invention to facilitate patients 1251 directly reporting medical device complaints to a medical device manufacturer 1257. To implement the process 1250, the patient 1251 provides his or her name 1252 and the medical device UDI 1253. Then, by using a computing device 1254 or phone/fax 1255 the patient enters a description of the complaint along with his or her name 1252 and the UDI 1253. The complaints and associated UDI are then provided to the manufacturer 1257, for example, via a secure HIPPA gateway 1256 or the phone/facsimile 1255.

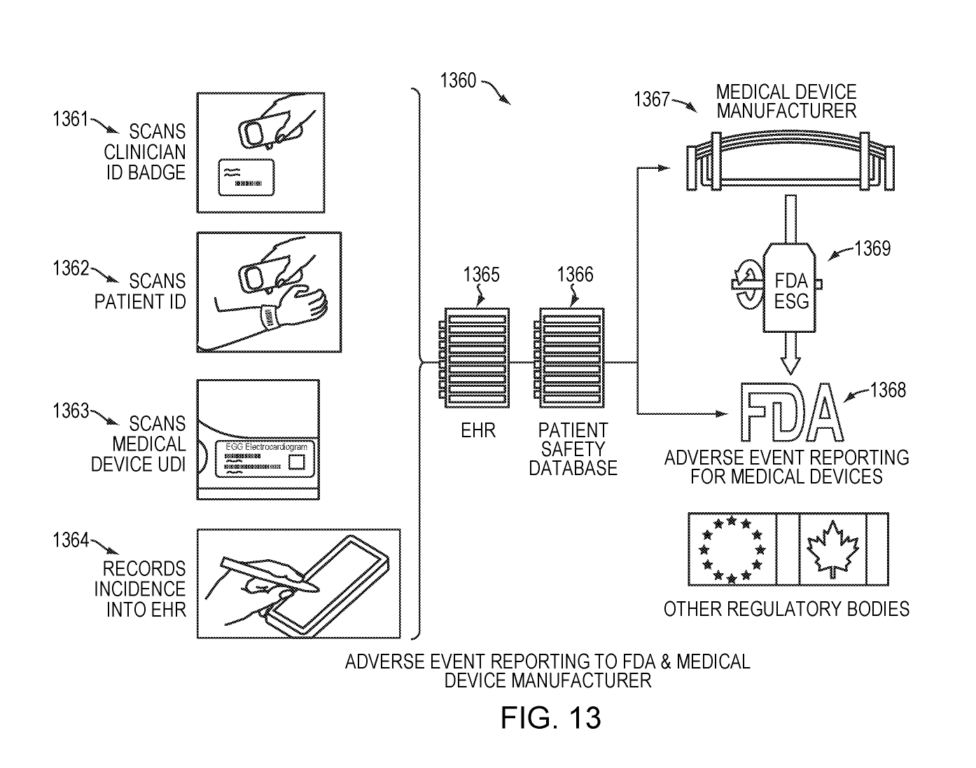

A process 1360 of reporting adverse events to regulatory bodies, e.g., the FDA 1368 and device manufacturers 1367, according to an embodiment of the present invention, is depicted in FIG. 13. The reporting process 1360 begins when a clinician scans his or her own identification 1361. The clinician then scans the patient's ID 1362 and continues the process by scanning or manually entering the device UDI 1363. The clinician continues the process by entering a description of the medical device complaint into the patient electronic health records database 1364. The complaint stored on the electronic health records database 1365 is then transferred to the patient safety database 1366. Complaints are then forwarded from the patient safety database 1366 to the device manufacturer 1367 and/or regulatory body 1368. Furthermore, the manufacturer 1367 can provide complaints to the regulatory body 1368 via the FDA ESG database 1369.

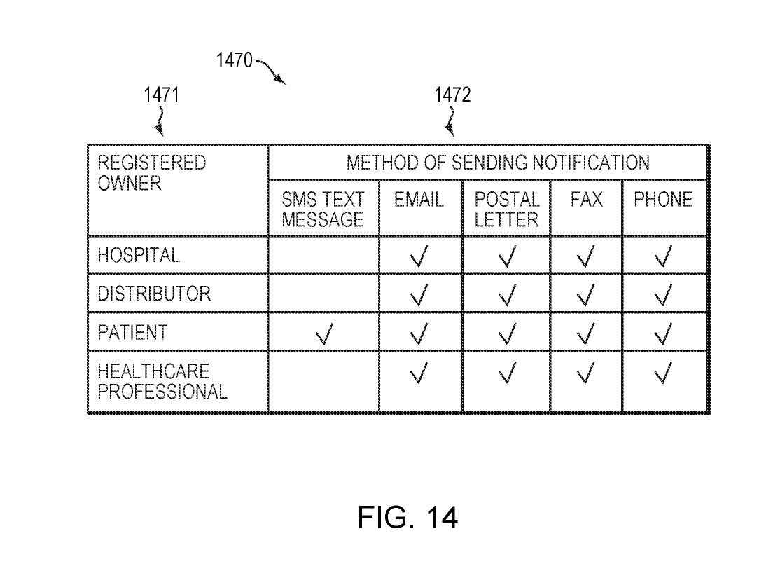

FIG. 14 is a table 1470 illustrating non-limiting example methods 1472 of sending device notifications to registered owners 1471 of medical devices. As shown in the table 1470, hospitals, device distributors, and healthcare professionals may receive notifications via email, postal letter, fax, and phone. Similarly, patients may receive notifications via SMS text message, email, postal letter, fax, and phone. The table 1470 provides non-limiting examples of methods 1472 of sending notifications to registered owners 1471. Embodiments of the present invention are not so limited and any medical device owner and/or person affected by medical device safety may be notified of a medical device complaint via any means known in the art.

Embodiments of the present invention, such as the method 330 described hereinabove in relation to FIG. 3 may generate a notification contact/verification dashboard or other graphical user interface that illustrates the status of notifications and acknowledgements. An example dashboard 1580 is shown in FIG. 15. The dashboard may contain any variety of information about the notification and acknowledgment. For example, such data may include the name of the registered owner along with their contact information, e.g. cell phone, home phone, address, and fax and even the name of a secondary contact such as a family member or caretaker. The dashboard can also include data about the notifications themselves, such as the sending method, type of notification sent, date and time the notification was sent, and acknowledgement that the registered owner received the notification. The dashboard may also include a recording of any follow-up messages that resulted from the registered owner calling for further information.

The dashboard can also facilitate alerting users, e.g., manufacturers, of delays in expected notification receipts. Embodiments of the invention have the functionality to set a delay time from the time the notification has been sent, to the expected time that the registered owner was to receive the notification. If the system does not receive a receipt notification within a specified time, the system can indicate this delay to a user (manufacturer). For example, color, shading, or labeling may be used to indicate that the registered owner has not provided receipt of the notification. These indications can serve to flag device owners that require follow-up attention. Various scales can be used to indicate the status of notifications. For example, if color codes are used, green may indicate the confirmation has been received, yellow can indicate the notification is sent but no receipt acknowledgment has been received, and red can indicate that no receipt confirmation has been received in a set time frame.

Embodiments of the present invention can send notifications via SMS text messaging and email to smartphones, tablets, and/or PC's for those registered users and secondary contacts that have selected text messaging and/or email as a method of communication. The content of the text/email can be in compliance with HIPAA standards for patient confidentiality. For example, a notification may read “Please contact MDT regarding your medical device for urgent notification information.” Text messaging and email ensure that the registered owners and secondary contacts (e.g. caretakers) are promptly notified of any medical device issues because they can be notified anywhere at any time as long as there is cellular and/or internet connectivity.

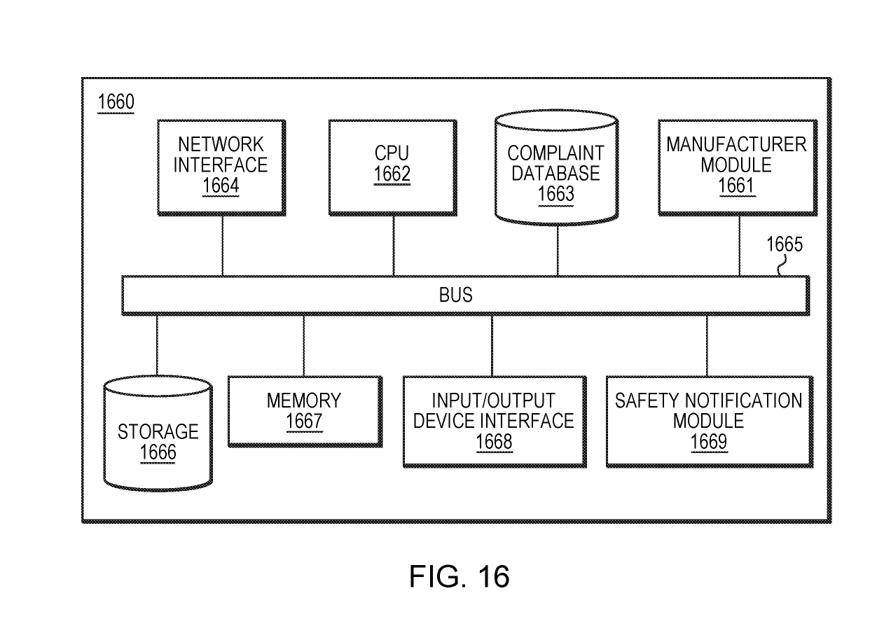

FIG. 16 is a simplified block diagram of a computer-based system 1660 that may be used to generate and send medical device safety notifications according to an embodiment. The system 1660 comprises a bus 1665. The bus 1665 serves as an interconnect between the various components of the system 1660. Connected to the bus 1665 is an input/output device interface 1668 for connecting various input and output devices such as a keyboard, mouse, display, speakers, etc. to the system 1660. A central processing unit (CPU) 1662 is connected to the bus 1665 and provides for the execution of computer instructions. Memory 1667 provides volatile storage for data used for carrying out computer instructions. Storage 1666 provides non-volatile storage for software instructions, such as an operating system (not shown). The system 1660 also comprises a network interface 1664 for connecting to any variety of networks known in the art, including wide area networks (WANs) and local area networks (LANs).

A complaint database 1663 is further connected to the bus 1665. The complaint database 1663 is configured to receive and store indications of received medical device complaints, each complaint including a respective UDI of a corresponding medical device. In such an embodiment of the system 1660, the medical device complaints may be received through any communication means known in the art. For example, the complaints may be received via the network interface 1664 from any communicatively coupled device and/or the input/output device interface 1668. Moreover, while the complaint database 1663 is illustrated as a standalone component, the complaint database 1663 may alternatively be incorporated into the storage 1666. Further still, the complaint database 1663 need not be directly connected to the system 1660 and may, for example, be located remotely.

A manufacturer module 1661 is operatively coupled via the bus 1665 to the complaint database 1663 and is configured to, for each received medical device complaint, automatically notify a respective manufacturer of the corresponding medical device. The manufacturer module 1661 may notify the respective manufacturers through any communication means known in the art. For example, the network interface 1664 may be utilized to facilitate the complaint being sent to the manufacturers. Furthermore, in an alternative embodiment, the manufacturer module 1661 may be configured to send the complaints to manufacturers only under certain conditions. For example, when a pre-determined number of medical device complaints have been received.

The system 1660 further includes a safety notification module 1669. The safety notification module 1669 is configured to generate and send safety notifications about the corresponding medical device in response to receiving instructions from the respective manufacturer. In such an embodiment, the instructions may be received and the notification sent, via any communications means known in the art. Further, safety notifications may be generated and sent based upon standing instructions, e.g., upon receiving a complaint always send safety notifications.

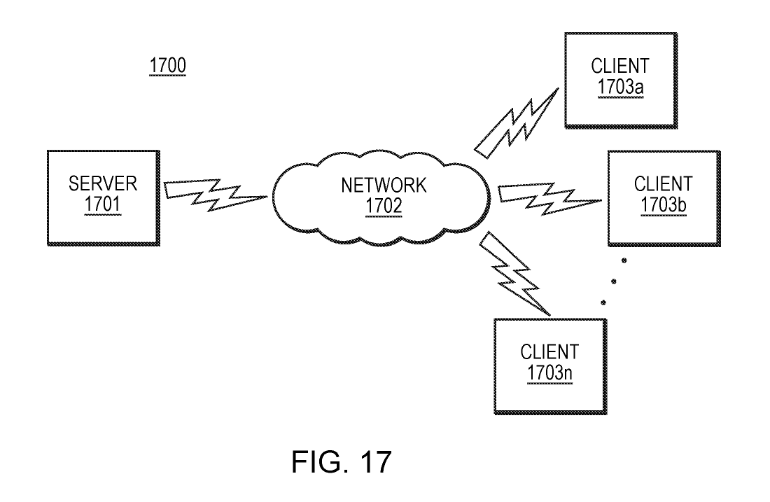

It should be understood that the example embodiments described herein may be implemented in many different ways. In some instances, the various methods and machines described herein may each be implemented by a physical, virtual, or hybrid general purpose computer, such as the computer system 1660, or a computer network environment such as the computer environment 1700, described herein below in relation to FIG. 17. The computer system 1660 may be transformed into the machines that execute the methods described herein, for example, by loading software instructions into either memory 1667 or non-volatile storage 1666 for execution by the CPU 1662. Further, while the manufacturer module 1661 and safety notification module 1669 are shown as separate modules, in an example embodiment, these modules may be implemented using a variety of configurations. One of ordinary skill should further understand that the system 1660 and its various components may be configured to carry out any embodiments of the present invention described herein.

FIG. 17 illustrates a computer network environment 1700 in which an embodiment of the present invention may be implemented. In the computer network environment 1700, the server 1701 is linked through the communications network 1702 to the clients 1703a-n. The environment 1700 may be used to allow the clients 1703a-n, alone or in combination with the server 1701, to execute any of the methods described hereinabove.

Embodiments or aspects thereof may be implemented in the form of hardware, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus, the data processors described herein are intended for purposes of illustration only and not as a limitation of the embodiments.

While this invention has been particularly shown and described with references to example embodiments thereof, it will be understood by those skilled in the art that various changes in form and details may be made therein without departing from the scope of the invention encompassed by the appended claims.

What is claimed is:

1. A computer implemented method for medical device safety notification, the method comprising:
receiving, by a digital processor, medical device complaints;
storing, by the digital processor, indications of the received medical device complaints in a memory coupled to the digital processor, each complaint including a respective unique device identifier (UDI) of a corresponding medical device;
for each received medical device complaint, automatically notifying a respective manufacturer of the corresponding medical device; and
in response to receiving instructions from the respective manufacturer, generating and sending safety notifications about the corresponding medical device.

2. The method of claim 1 wherein the medical device complaints are received from at least one of:
a patient;
a hospital;
a health care provider; and
a complaint database.

3. The method of claim 1 wherein the safety notifications are sent in a HIPPA compliant manner.

4. The method of claim 1 wherein the safety notifications are automatically sent to at least one of:
a patient;
a hospital;
a health care provider; and
a regulatory body.

5. The method of claim 1 wherein the safety notifications are automatically sent via at least one of:
SMS text message;
email;
letter;
facsimile; and
phone.

6. The method of claim 1 further comprising:
determining acknowledgement status of sent safety notifications.

7. The method of claim 1 further comprising:
determining recipients of the safety notifications.

8. The method of claim 7 wherein the safety notifications are sent based upon respective preferences of the recipients.

9. The method of claim 7 wherein the recipients are determined using a database of UDIs.

10. A system for medical device safety notification, the system comprising:
a complaint database configured to receive and store indications of received medical device complaints, each complaint including a respective unique device identifier (UDI) of a corresponding medical device;
a manufacturer module configured to, for each received medical device complaint, automatically notify a respective manufacturer of the corresponding medical device; and
a safety notification module configured to generate and send safety notifications about the corresponding medical device in response to receiving instructions from the respective manufacturer.

11. The system of claim 10 wherein the medical device complaints are received from at least one of:
a patient;
a hospital;
a health care provider; and
a complaint database.

12. The system of claim 10 configured to send the safety notifications in a HIPPA compliant manner.

13. The system of claim 10 wherein the safety notification module is further configured to automatically send the safety notifications to at least one of:
a patient;
a hospital;
a health care provider; and
a regulatory body.

14. The system of claim 10 wherein the safety notification module is further configured to automatically send the safety notifications via at least one of:
SMS text message;
email;
letter;
facsimile; and
phone.

15. The system of claim 10 wherein the safety notification module is further configured to determine acknowledgement status of sent safety notifications.

16. The system of claim 10 wherein the safety notification module is further configured to determine recipients of the safety notifications.

17. The system of claim 16 wherein the safety notification module is further configured to send the safety notifications based upon respective preferences of the recipients.

18. The system of claim 16 wherein the safety notification module is configured to determine the recipients using a database of UDIs.

19. A computer program product executed by a server in communication across a network with one or more clients, the computer program product comprising:
a computer readable medium, the computer readable medium comprising program instructions which, when executed by a processor causes:
receiving by a digital processor, medical device complaints;
storing, by the digital processor, indications of the received medical device complaints in a memory coupled to the digital processor, each complaint including a respective unique device identifier (UDI) of a corresponding medical device;
for each received medical device complaint, automatically notifying a respective manufacturer of the corresponding medical device; and
in response to receiving instructions from the respective manufacturer, generating and sending safety notifications about the corresponding medical device.

20. The computer program product of claim 19 wherein the medical device complaints are received from at least one of:
a patient;
a hospital;
a health care provider; and
a complaint database.
